(19) United States
(12) Patent Application Publication
(10) Pub. No.: US 2020/0398728 A1
(43) Pub. Date: Dec. 24, 2020

(54) TELESCOPING LOADING RAMP

(71) Applicant: Christy Thomason, Phenix City, AL (US)

(72) Inventor: Christy Thomason, Phenix City, AL (US)

(21) Appl. No.: 16/449,475

(22) Filed: Jun. 24, 2019

(51) Int. Cl. B60P 1/43; B62D 33/027

(52) U.S. Cl. CPC B60P 1/435; B62D 33/0273

(57) ABSTRACT

Implementations of a telescoping loading ramp are provided. In some implementations, the telescoping loading ramp comprises a left bracket and a right bracket configured to attach to a vehicle tailgate, a first ramp section rotatably attached to the left and the right brackets, and a plurality of telescoping ramp sections. In some implementations, each of the first ramp section and the telescoping ramp sections comprises a continuous top surface thereby forming a continuous ramp structure that extends widthwise between the left bracket and the right bracket and extends lengthwise from the vehicle to a supporting surface.

### TECHNICAL FIELD

This disclosure relates to implementations of a telescoping loading ramp.

### BACKGROUND

Pickup trucks and similar vehicles include a tailgate to open and close access to the truck bed. A ramp or similar structure can be fashioned and used to further provide access to the truck bed between the tailgate and the ground or other surface.

U.S. Patent Appl. Pub. No. 2010/0089698 (“'698 Patent Appl.”) discloses a folding ladder that hooks to a pickup truck tailgate to assist a person getting into and out of the truck bed. However, the '698 Patent Appl. does not disclose a ramp structure that telescopes outwardly and inwardly. The '698 Patent Appl. also does not disclose a ramp structure that extends from one side of the tailgate to the other. Furthermore, the '698 Patent Appl. does not disclose a ramp structure that is continuous for walking or sliding items upon.

U.S. Pat. No. 5,205,603 (“'603 patent”) discloses a ladder assembly mounted slidably and telescopingly within a tailgate portion of a truck bed to provide ease of access to the truck bed. However, the '603 patent does not disclose a ramp structure that is continuous for walking or sliding items upon. The '603 patent also does not disclose a ramp structure that extends from one side of the tailgate to the other. Furthermore, the '603 patent does not disclose a ramp structure that flips on top of the tailgate in a stored configuration.

Also, some vehicle manufacturers have truck models that include a step-up ladder or built-on ladder, but do not have models that include a walking/loading ramp.

### BRIEF DESCRIPTION OF THE DRAWINGS

FIG. 1 illustrates an implementation of an example telescoping loading ramp in a usage configuration according to the present disclosure.

FIG. 2 illustrates an implementation of an example telescoping loading ramp in a storage configuration according to the present disclosure.

FIG. 3 illustrates an example plurality of ramp sections of the telescoping loading ramp.

FIG. 4 illustrates another implementation of an example telescoping loading ramp in a usage configuration according to the present disclosure.

FIG. 5 illustrates another implementation of an example telescoping loading ramp in a storage configuration according to the present disclosure.

FIGS. 6 and 7 illustrate the telescoping loading ramp of FIGS. 1-3 and 4-5 respectively in an unattached storage configuration for purchase and installation.

### DETAILED DESCRIPTION

Implementations of a telescoping loading ramp are provided. In some implementations, the telescoping loading ramp comprises a left bracket and a right bracket configured to attach to a vehicle tailgate.

In some implementations, the telescoping loading ramp comprises a first ramp section rotatably attached to the left bracket and the right bracket.

In some implementations, the telescoping loading ramp comprises a plurality of telescoping ramp sections.

In some implementations, each of the first ramp section and the telescoping ramp sections comprises a continuous top surface thereby forming a continuous ramp structure that extends widthwise between the left bracket and the right bracket and extends lengthwise from the vehicle to a supporting surface.

In some implementations, the telescoping loading ramp has a width that extends from one side of the tailgate to the other side of the tailgate.

In some implementations, the telescoping loading ramp has continuous, wide surface.

In this way, the telescoping loading ramp allows smooth loading and walking access to/from a truck bed.

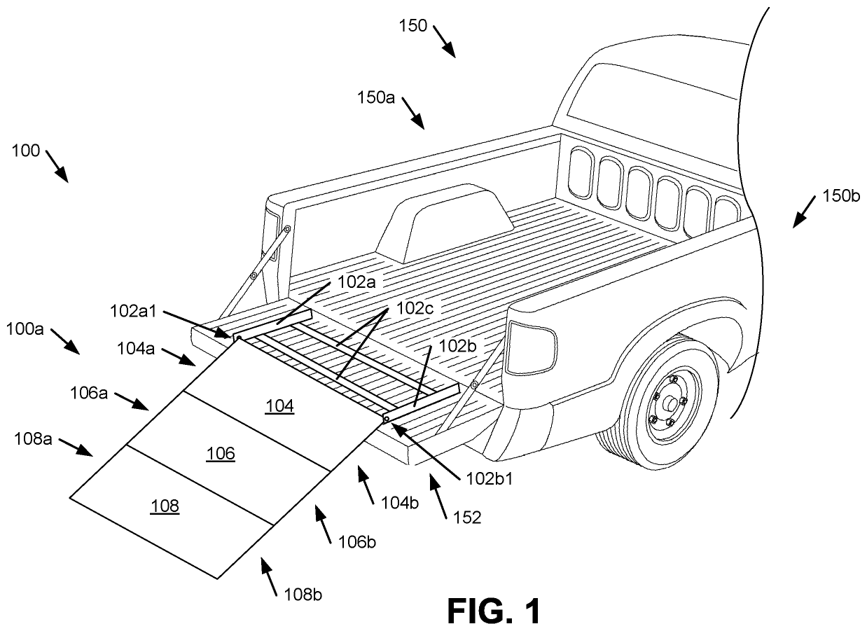

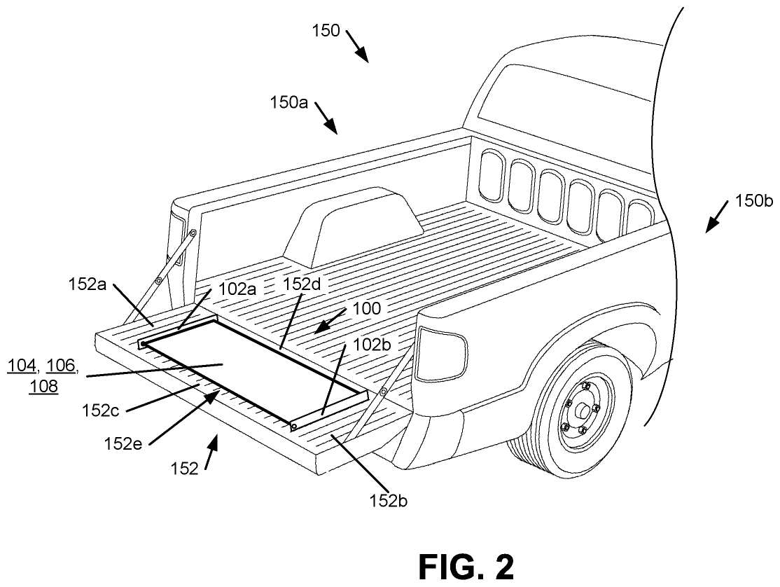

FIGS. 1 and 2 illustrate an implementation of an example telescoping loading ramp 100 according to the present disclosure. FIG. 1 illustrates the telescoping loading ramp 100 in an example extended/usage configuration. FIG. 2 illustrates the telescoping loading ramp 100 in an example storage configuration.

As shown in FIGS. 1 and 2, in some implementations, the telescoping loading ramp 100 comprises a left bracket 102a, a right bracket 102b, and a plurality of ramp sections (for example, a first ramp section 104, a second ramp section 106, and a third ramp section 108). As shown in FIG. 1, in some implementations, the telescoping loading ramp 100 may further comprise one or more connecting brackets 102c.

In some implementations, the left bracket 102a and the right bracket 102b are elongated. In some implementations, the left bracket 102a and the right bracket 102b may be any suitable shape.

In some implementations, the connecting brackets 102c are elongated. In some implementations, the connecting brackets 102c may be any suitable shape.

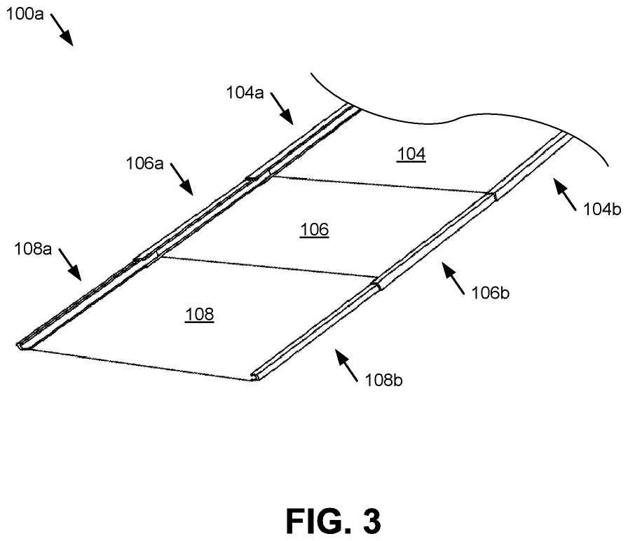

FIG. 3 illustrates an example plurality of ramp sections 104, 106; 108 of the telescoping loading ramp 100. As shown in FIG. 3, in some implementations, the telescoping loading ramp 100 comprises three ramp sections 104, 106; 108. In some implementations, the telescoping loading ramp 100 may comprise more than three ramp sections. In some implementations, the telescoping loading ramp 100 may comprise less than three ramp sections.

As shown in FIGS. 1 and 2, in some implementations, the telescoping loading ramp 100 is configured to attach to a tailgate 152 of a vehicle 150.

As shown in FIG. 2, in some implementations, the tailgate 152 comprises a top surface 152e extending width-wise from a left side 152a to an opposite, right side 152b and extending length-wise from a top side 152c to an opposite, bottom side 152d. In some implementations, the top surface 152e is planar shaped. In some implementations, the top surface 152e is upward facing when the tailgate 152 is in a fully open position.

In some implementations, the left side 152a is adjacent to a left side 150a of the vehicle 150. In some implementations, the right side 152b is adjacent to a right side 150b of the vehicle 150. In some implementations, the top side 152c of the top surface 152e is distal to the vehicle and the bottom side 152d is proximal to the vehicle when the tailgate 152 is in a fully open position.

As shown in FIG. 2, in some implementations, the left bracket 102a and the right bracket 102b are configured to attach the tailgate 152. In some implementations, the left bracket 102a attaches to the tailgate left side 152a. In some implementations, the right bracket 102b attaches to the tailgate right side 152b. In some implementations, the left bracket 102a and right bracket 102b may attach respectively to any other portion of the tailgate top surface 152e.

In some implementations, the left bracket 102a and the right bracket 102b are configured to attach to the tailgate 152 with a screw fastener. In some implementations, the left bracket 102a and the right bracket 102b are configured to attach to the tailgate 152 with a bolt fastener. In some implementations, the left bracket 102a and the right bracket 102b are configured to attach to the tailgate 152 with a clamp fastener. In some implementations, the left bracket 102a and the right bracket 102b are configured to attach to the tailgate 152 in any other suitable manner. One of ordinary skill in the art with the benefit of this disclosure would know how to attach the left bracket 102a and the right bracket 102b to the tailgate 152.

As shown in FIG. 1, in some implementations, the connecting brackets 102c are configured to attach to the left bracket 102a and the right bracket 102b. In some implementations, the connecting brackets 102c are configured to extend between the left bracket 102a and the right bracket 102b.

In some implementations, the connecting brackets 102c are configured to support the left bracket 102a and the right bracket 102b. In some implementations, the connecting brackets 102c are configured to maintain the spacing between the left bracket 102a and the right bracket 102b.

As shown in FIG. 3, in some implementations, each of the ramp sections (e.g., ramp sections 104, 106, 108) is planar panel shaped. In some implementations, each of the ramp sections may be any other suitable shape.

In some implementations, each ramp section comprises a top surface that extends width-wise from a left side to an opposite, right side and extends length-wise from a top side to an opposite bottom side. In this way, the loading ramp 100 is continuous for walking or sliding items upon when the loading ramp 100 is extended. As shown in FIG. 1, in some implementations, the top side of each ramp section is distal to the vehicle and the bottom side is proximal to the vehicle when the ramp section is in an extended position.

As shown in FIG. 1, in some implementations, the left side 104a of the first ramp section 104 is rotatably attached to the left bracket 102a and the right side 104b of the first ramp section 104 is rotatably attached to the right bracket 102b. In some implementations, the first ramp section 104 extends width-wise from the left bracket 102a to the right bracket 102b.

As shown in FIG. 1, in some implementations, the first ramp section 104 is rotatably attached to the left bracket 102a and to the right bracket 102b respectively by a fastener 102a1, 102b1. In some implementations, the fastener 102a1, 102b1 may be a bolt fastener. In some implementations, the fastener 102a1, 102b1 may be a pin fastener. In some implementations, the fastener 102a1, 102b1 may be any other suitable fastener.

In some implementations, the first ramp section 104 may be rotatably attached to the left bracket 102a and to the right bracket 102b in any other suitable manner. One of ordinary skill in the art with the benefit of this disclosure would know how to rotatably attach the first ramp section 104 to the left bracket 102a and to the right bracket 102b.

In some implementations, each ramp section, except the ramp section attached to the left bracket 102a and to the right bracket 102b, is telescopably attached to an adjacent proximal ramp section. That is, in some implementations, each ramp section, except the ramp section attached to the left bracket 102a and to the right bracket 102b, is telescopably attached to an adjacent ramp section closer to the vehicle.

In some implementations, each telescoping ramp section is configured to telescopably retract on top of or behind the adjacent proximal ramp section such that the telescoping ramp section is stacked adjacent to the adjacent proximal ramp section. In some implementations, each telescoping ramp section is configured to telescopably extend away from the adjacent proximal ramp section to a position such that the bottom side of the telescoping ramp section is adjacent to the top side of the adjacent proximal ramp section (wherein such top side and bottom side of the ramp sections are similarly oriented as the top side 152c and the bottom side 152d are oriented on the tailgate 152, as described above).

For example, as shown in FIG. 1, in some implementations, the second ramp section 106 is telescopably attached to the first ramp section 104. In some implementations, the second ramp section 106 is configured to telescopably retract on top of or behind the first ramp section 104 such that the second ramp section 106 is stacked adjacent to the first ramp section 104. In some implementations, the second ramp section 106 is configured to telescopably extend away from the first ramp section 104 to a position such that the bottom side of the second ramp section 106 is adjacent to the top side of the first ramp section 104.

Similarly, as shown in FIG. 1, in some implementations, the third ramp section 108 is telescopably attached to the second ramp section 106. In some implementations, the third ramp section 108 is configured to telescopably retract on top of or behind the first ramp such that the third ramp section 108 is stacked adjacent to the second ramp section 106. In some implementations, the third ramp section 108 is configured to telescopably extend away from the second ramp section 106 to a position such that the bottom side of the third ramp section 108 is adjacent to the top side of the second ramp section 106.

In some implementations, the ramp sections are attached and interact similarly to the above described configurations when there are more than or less than three ramp sections.

As shown in FIG. 3, in some implementations, each ramp section is telescopably attached to an adjacent proximal ramp section by interlocking telescoping channels. For example, in some implementations, each ramp section comprises interlocking telescoping channels on its right side and left side which telescopably connect respectively to interlocking telescoping channels on the right side and left side of an adjacent proximal ramp section.

For example, the second ramp section 106 comprises interlocking telescoping channels on its right side 106b and left side 106a which telescopably connect respectively to interlocking telescoping channels on the right side 104b and left side 104a of the first ramp section 104.

Similarly, the second ramp section 108 comprises interlocking telescoping channels on its right side 108b and left side 108a which telescopably connect respectively to interlocking telescoping channels on the right side 106b and left side 106a of the second ramp section 106.

In some implementations, the ramp sections are attached and interact similarly to the above described interlocking channel configurations when there are more than or less than three ramp sections.

In some implementations, each ramp section may be telescopably attached to an adjacent proximal ramp section in any other suitable manner. One of ordinary skill in the art with the benefit of this disclosure would know how to telescopably attach a ramp section to an adjacent ramp section.

As shown in FIG. 1, in some implementations, the plurality of ramp sections 104, 106, 108 are configured to form a continuous ramp structure 100a when the first ramp section 104 is rotated away from the vehicle 150 and one or more of the telescoping ramp sections are telescopably extended away from the adjacent proximal ramp section.

In some implementations, the continuous ramp structure 100a extends widthwise between the left bracket 102a and the right bracket 102b.

In some implementations, the continuous ramp structure 100a extends lengthwise away from the vehicle 150 between a position adjacent to the tailgate top side 152c and a supporting surface (e.g., a ground, floor, or any other surface not connected to the vehicle 150).

Referring to FIG. 2, in some implementations, the plurality of ramp sections 104, 106, 108 are configured to be stored on the tailgate 152 when each of the telescoping ramp sections is telescopably retracted on top of or behind the adjacent proximal ramp section such that the telescoping ramp section is stacked adjacent to the adjacent proximal ramp section and the first ramp section 104 is rotated on top of the tailgate 152.

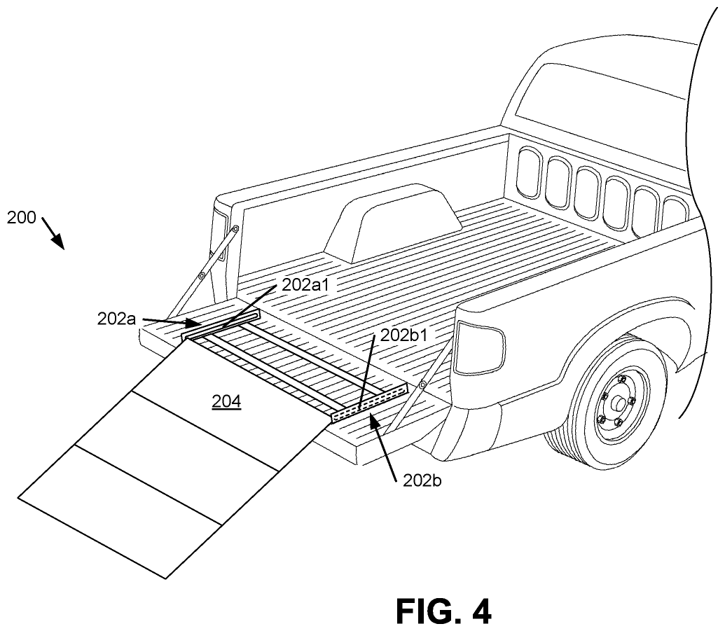

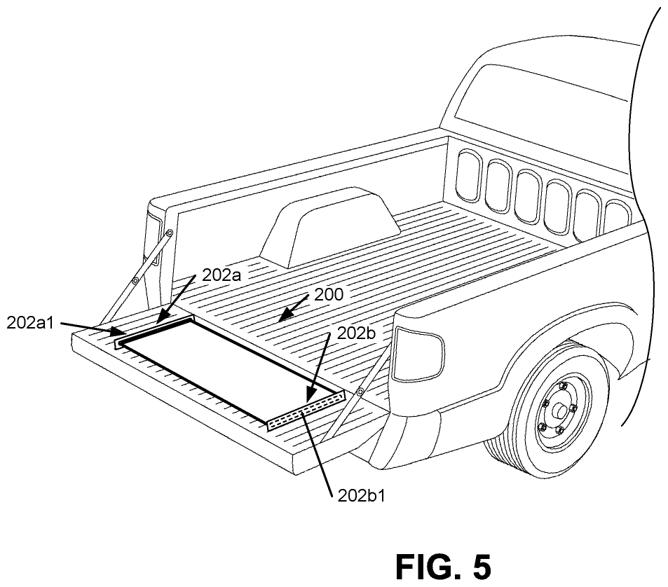

FIGS. 4 and 5 illustrate another implementation of an example telescoping loading ramp 200 according to the present disclosure. FIG. 4 illustrates the telescoping loading ramp 200 in an example extended/usage configuration. FIG. 5 illustrates the telescoping loading ramp 100 in an example storage configuration.

In some implementations, the telescoping loading ramp 200 is substantially the same or similar in all aspects to the above described telescoping loading ramp 100 for FIGS. 1-3. However, in contrast to the above described telescoping loading ramp 100, as shown in FIG. 4, in some implementations, the first ramp section 204 of the telescoping loading ramp 200 is slideably and/or retractably attached to the left bracket 202a and to the right bracket 202b by slots 202a1, 202b1 respectively, instead of rotatably attached.

For example, in some implementations, the first ramp section 204 is slideably and/or retractably attached to the left bracket 202a and to the right bracket 202b by a fastener (such as a bolt or pin, similar to the above described fastener 102a1, 102b1) extending from the ramp section 204 into the slots 202a1, 202b1 respectively.

As shown in FIGS. 4 and 5, in some implementations, the ramp sections of the telescoping loading ramp 200 can therefore be slided and/or retracted along the slots 202a1, 202b1 to be extended from (i.e., to be used) and/or positioned between (i.e., to be stored) the brackets 202a, 202b respectively.

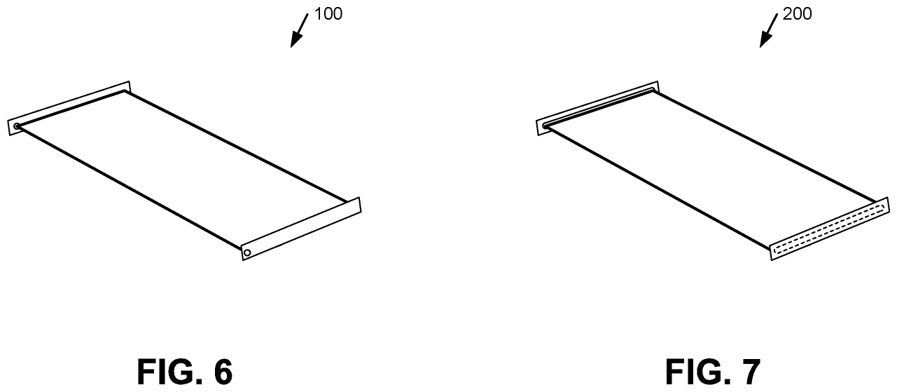

FIGS. 6 and 7 illustrate the telescoping loading ramp 100, 200 of FIGS. 1-3 and 4-5 respectively in an unattached storage configuration for purchase and/or installation to a vehicle tailgate as described above.

In some implementations, the telescoping loading ramp 100, 200 comprises any suitable dimensions.

In some implementations, the telescoping loading ramp 100, 200 is composed of aluminum. In some implementations, the telescoping loading ramp 100, 200 is composed of any other suitable material.

In some implementations, the telescoping loading ramp 100, 200 can have any suitable appearance.

In some implementations, an example method of using the telescoping loading ramp 100, 200 comprises installing, extending, storing, and/or using the telescoping loading ramp 100, 200 in accordance with the above described features. In some implementations, the method may comprise any other suitable actions, operations, etc. in accordance with and/or with the benefit of the disclosure herein.

The figures, including photographs and drawings, comprised herewith may represent one or more implementations of the telescoping loading ramp.

Details shown in the figures, such as dimensions, descriptions, etc., are exemplary, and there may be implementations of other suitable details according to the present disclosure.

Reference throughout this specification to “an embodiment” or “implementation” or words of similar import means that a particular described feature, structure, or characteristic is comprised in at least one embodiment of the present invention. Thus, the phrase “in some implementations” or a phrase of similar import in various places throughout this specification does not necessarily refer to the same embodiment.

Many modifications and other embodiments of the inventions set forth herein will come to mind to one skilled in the art to which these inventions pertain having the benefit of the teachings presented in the foregoing descriptions and the associated drawings.

The described features, structures, or characteristics may be combined in any suitable manner in one or more embodiments. In the above description, numerous specific details are provided for a thorough understanding of embodiments of the invention. One skilled in the relevant art will recognize, however, that embodiments of the invention can be practiced without one or more of the specific details, or with other methods, components, materials, etc. In other instances, well-known structures, materials, or operations may not be shown or described in detail.

While operations may be depicted in the drawings in a particular order, this should not be understood as requiring that such operations be performed in the particular order shown or in sequential order, or that all illustrated operations be performed, to achieve desirable results.

1. A telescoping loading ramp for attachment to a tailgate of a vehicle, wherein the tailgate comprises a top surface extending width-wise from a left side to an opposite, right side and extending length-wise from a top side to an opposite bottom side wherein the top surface is upward facing when the tailgate is in a fully open position the left side is adjacent to a left side of the vehicle, the right side is adjacent to a right side of the vehicle and the top side of the top surface is distal to the vehicle and the bottom side is proximal to the vehicle when the tailgate is in a fully open position, the telescoping loading ramp comprising:
a left bracket that is elongated and attached to the top surface of the tailgate on a first side of the tailgate;
a right bracket that is elongated and attached to the top surface of the tailgate on an opposite, second side of the tailgate;
a first ramp section wherein the left side of the first ramp section is rotatably attached to the left bracket and the right side of the first ramp section is rotatably attached to the right bracket; and
a plurality of telescoping ramp sections,
wherein each of the first ramp section and the telescoping ramp sections comprises a continuous top surface that extends width-wise from a left side to an opposite, right side and extend length-wise from a top side to an opposite bottom side wherein the top side is distal to the vehicle and the bottom side is proximal to the vehicle when the ramp section is an extended position;
wherein each telescoping ramp section is telescopably attached to an adjacent proximal ramp section and configured to telescopably retract on top of or behind the adjacent proximal ramp section such that the telescoping ramp section is stacked adjacent to the adjacent proximal ramp section and configured to telescopably extend away from the adjacent proximal ramp section to a position such that the bottom side of the telescoping ramp section is adjacent to the top side of the adjacent proximal ramp section;
wherein the first ramp section and the telescoping ramp sections are configured to form a continuous ramp structure that extends widthwise between the left bracket and the right bracket and extends lengthwise from the vehicle to a supporting surface when the first ramp section is rotated away from the vehicle and each of one or more of the telescoping ramp sections is telescopably extended away from an adjacent proximal ramp section; and
wherein the first ramp section and the telescoping ramp sections are configured to be stored on top of the tailgate when each of the telescoping ramp sections is telescopably retracted on top of or behind an adjacent proximal ramp section such that the telescoping ramp section is stacked adjacent to the adjacent proximal ramp section and the first ramp section is rotated on top of the tailgate.

2. The telescoping loading ramp of claim 1, wherein the left bracket is attached to the tailgate left side and the right bracket is attached to the tailgate right side.
